(19) United States
(12) Patent Application Publication
(10) Pub. No.: US 2026/0275240 A1
(43) Pub. Date: Sep. 17, 2026

(54) TREATMENT COMPOSITIONS

(71) Applicant: The Procter & Gamble Company, Cincinnati, OH (US)

(72) Inventors: Robert Richard DYKSTRA, West Chester, OH (US); Shannon Leah GOES, Cincinnati, OH (US); Heather Nicole SMILEY, West Chester, OH (US); Ronald GENTRY, Cincinnati, OH (US)

(21) Appl. No.: 19/077,185

(22) Filed: Mar. 12, 2025

(51) Int. Cl. C11D 3/00; C11D 3/37

(52) U.S. Cl. CPC C11D 3/0015; C11D 3/3719; C11D 2111/12

(57) ABSTRACT

The present disclosure relates to liquid fabric treatment compositions comprising, based upon total composition weight from about 0.01% to about 2% of a MMW polymer derived from the polymerization of from about 5 to 100 mole percent of a cationic vinyl addition monomer, from about 0 to 95 mole percent of a non-ionic vinyl addition monomer, wherein the molecular weight of the MMW polymer is from about 400,000 to about 1,800,000 Daltons, and from about 1% to about 25% of a fabric softener active material.

### FIELD OF THE INVENTION

The present invention relates to treatment compositions and processes of making and using same.

### BACKGROUND OF THE INVENTION

Treatment compositions, such as fabric treatment compositions, and even more particularly liquid fabric treatment compositions, typically comprise “benefit agents” such as fabric softeners, silicones, perfumes, and perfume microcapsules. Generally, there are trade-offs associated with using multiple benefit agents in a single treatment composition. Such trade-offs may include the loss or reduction of benefit efficacy of one or more of the benefit agents, as well as the potential loss or reduction of the treatment composition's overall desired physical property attributes—such as, for example, stability and rheology.

Employing a traditional linear polymer system can improve a treatment composition's targeted performance benefits and physical property attributes, however, traditional linear polymer systems do not solve the longstanding problem of when increasing one benefit agent or attribute, there is a decrease in the efficacy of other benefit agents. For example, when employing a traditional linear polymer system that specifically targets an improvement in softener active deposition efficiency, there will still be a decrease in the performance efficiency of the encapsulated perfume and neat oil perfume with respect to release of perfume raw materials. And when employing a traditional linear polymer system that specifically targets improvement of perfume efficiency, there is not any increase delivered to softness efficiency or treatment composition stability and rheology. Further, the proper selection of a linear polymer system is necessary to minimize possible phase separation of the treatment composition, which is believed to be due to depletion flocculation associated with linear polymers. In addition, a proper selection of a linear polymer system is also necessary to achieve the preferred composition viscosity, avoiding being too low or too high, which would require use of additional structurants if too low, or other additives to reduce viscosity which may negatively impact phase stability.

Accordingly, traditionally there has been a continual balancing of benefit agent levels to achieve the most desired overall treatment composition. To assist this balancing dilemma, the consumer product industry needs new formulations that include new specific linear polymer systems.

### SUMMARY OF THE INVENTION

A liquid fabric treatment composition comprising, based upon total composition weight, from about 0.01% to about 2% of a MMW polymer derived from the polymerization of from about 5 to 100 mole percent of a cationic vinyl addition monomer, from about 0 to 95 mole percent of a non-ionic vinyl addition monomer, wherein the molecular weight of the MMW polymer is from about 400,000 to about 1,800,000 Daltons, and from about 1% to about 25% of a fabric softener active material.

### DETAILED DESCRIPTION OF THE INVENTION

The present disclosure relates to treatment compositions, for example liquid fabric treatment compositions, containing polymer systems that improve benefit agent deposition and release efficiency, while improving physical properties, such as stability and viscosity, of the rinse fabric enhancers, as well as methods of making and using same. Such treatment compositions may be used, for example, as through the wash and/or through the rinse fabric enhancers, well as unit dose treatment compositions.

Applicants have surprisingly observed that the traditional polymer system architecture was the source of the deposition, release, stability, and viscosity problems. In addition, Applicants now recognize that traditional polymer systems did not contribute to the overall softness and freshness benefit that was desired, while achieving desired product stability and rheology (e.g., viscosity). Applicants discovered that, for fabric enhancers, in particular low pH fabric enhancers, when coupled with the judicious selection one or more linear, non-cross-linked polymers with medium molecular weight (“MMW polymer”, as defined herein), the softener active level could be maintained or reduced to improve the composition's benefit active efficiency, yet the performance of softener active was surprisingly maintained.

While not being bound by theory, Applicants believe that the proper selection of such linear, medium molecular weight polymers provide an increase in the efficiency of encapsulated and unencapsulated (neat oil) benefit agents and/or softness active benefit agents, which are interpreted by consumers as a fabric having improved freshness and/or softer and more preferred feel. Such selections also enable preferred phase stability and product viscosity without compromising performance benefits.

Applicants also discovered that a polymer system that includes medium molecular weight linear (non-cross-linked) polymers can increase the viscosity of liquid fabric enhancers, thus reducing the need for increased level of high molecular weight cross-linked polymers (structurants). While not being bound by theory, such high molecular weight cross-linked polymers can also increase the viscosity of fabric enhancers, but do not always improve, and can sometimes decrease, the efficiency of benefit agents to improve freshness and/or softness.

### Definitions

As used herein, the term “treatment composition” means a subset of cleaning and treatment compositions that includes, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, car or carpet shampoos, bathroom cleaners including toilet bowl cleaners; and metal cleaners, fabric conditioning products including softening and/or freshening that may be in liquid, solid and/or dryer sheet form; as well as cleaning auxiliaries such as bleach additives and “stainstick” or pre-treat types, substrate-laden products such as dryer added sheets, dry and wetted wipes and pads, nonwoven substrates, and sponges; as well as sprays and mists. All such products which are applicable may be in standard, concentrated or even highly concentrated form even to the extent that such products may in certain aspect be nonaqueous.

As used herein, the term “liquid fabric treatment composition” means fabric care compositions, liquid fabric softening compositions, liquid fabric enhancing compositions, liquid fabric freshening compositions, freshness additives, laundry prewash, laundry pretreaters, laundry additives, spray products, dry cleaning agent or compositions, laundry rinse additives, wash additives, post-rinse fabric treatments, ironing aids, and other suitable forms that may be apparent to one skilled in the art in view of the teachings herein. Such compositions may be used as a pre-laundering treatment, a post-laundering treatment, or may be added during the rinse or wash cycle of the laundering operation.

As used herein, the term “situs” includes paper products, fabrics, garments, and hard surfaces.

As used herein, articles such as “a”, “an”, and “the” when used in a claim, are understood to mean one or more of what is claimed or described.

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Fabric Treatment Compositions

Fabric treatment compositions as described herein may comprise, based upon total composition weight, a polymer system that comprises from about 0.01% to about 2%, preferably from about 0.02% to about 0.5%, more preferably from about 0.03% to about 0.3%, even more preferably from about 0.04% to about 0.2%, most preferably from about 0.05% to about 0.12% MMW (medium molecular weight) linear polymer; and from about 1% to about 25%, preferably from about 3% to about 16%, more preferably from about 4% to about 12%, still more preferably from 5% to about 10%, most preferably from about 6% to about 8% of a fabric softener active material; and optionally, a population of perfume capsules with the proviso that said population of perfume capsules comprises a capsule wall material selected from the group consisting of melamine, polyacrylamide, silicones, silica, polystyrene, polyurea, polyurethanes, polyacrylate based materials, polyacrylate esters-based materials, gelatin, styrene malic anhydride, polyamides, aromatic alcohols, polyvinyl alcohol and mixtures thereof.

Such fabric treatment composition may have a viscosity from about 25 cPs to about 1000 cPs (about 25 mPa·s to about 1000 mPa·s), from about 50 cPs to about 700 cPs (about 50 mPa·s to about 700 mPa·s), from about 80 cPs to about 500 cPs (about 80 mPa·s to about 500 mPa·s), from about 90 cPs to about 400 cPs (about 90 mPa·s to about 400 mPa·s), or from 100 cPs to about 300 cPs, or from 95 cPs to about 250 cPs, or from 80 cPs to about 350 cPs, or from 100 cPs to about 200 cPs, or from 60 cPs to about 150 cPs.

The fabric treatment composition may be characterized by a dynamic yield stress. For example, the dynamic yield stress at 20° C. of the fabric softener composition may be from 0.001 Pa to 1.0 Pa, preferably from 0.005 Pa to 0.8 Pa, more preferably from 0.01 Pa to 0.5 Pa. The absence of a dynamic yield stress may lead to phase instabilities such as particle creaming or settling in case the liquid composition comprises suspended particles or encapsulated benefit agents. Very high dynamic yield stresses may lead to undesired air entrapment during filling of a bottle with the fabric softener composition. Dynamic yield stress is determined according to the method provided in the Test Methods section below.

The fabric treatment compositions of the present disclosure may be characterized by a pH of from about 2 to about 12, or from about 2 to about 8.5, or from about 2 to about 7, or from about 2 to about 5. The compositions of the present disclosure may have a pH of from about 2 to about 4, preferably a pH of from about 2 to about 3.7, more preferably a pH from about 2 to about 3.5, preferably in the form of an aqueous liquid. It is believed that acidic pH levels facilitate stability of the ester quat. The pH of a composition is determined by dissolving/dispersing the composition in deionized water to form a solution at 10% concentration, at about 20° C.

The fabric treatment compositions of the present disclosure may comprise water. The liquid conditioning composition may comprise from about 40% to about 98%, or from about 50% to about 96%, or from about 75% to about 95%, or from about 80% to about 94%, by weight of the composition, of water. Water levels may be selected to as to balance the amount of the softening active to a desired level. The selection of the ester quats described herein is believed to be particularly useful in compositions that comprise a relatively high amount of water, as such ingredients can provide both performance and viscosity-building benefits.

The fabric treatment compositions may be packaged in a pouring bottle. The liquid conditioning composition may be packaged in an aerosol can or other spray bottle. The packaging may be translucent or transparent.

The fabric treatment compositions of the present disclosure may further include one or more of the following ingredients set out below.

### MMW Polymer

The MMW Polymer may be derived from the polymerization of from about 10 to 100 mole percent, preferably 20 mole percent to 90 mole percent, more preferably 25 mole percent to 70 mole percent, and most preferably 30 mole percent to 65 mole percent of a cationic vinyl addition monomer (“Monomer 1”); and from about 5 to 90 mole percent, preferably 10 mole percent to 80 mole percent, more preferably 35 mole percent to 70 mole percent of a non-ionic vinyl addition monomer (“Monomer 2”).

In one aspect of the composition, the MMW Polymer has a Monomer 1 to Monomer 2 weight percent ratio of from about 25:75 to about 100:0, preferably from about 40:60 to about 90:10, more preferably from about 50:50 to about 85:15, even more preferably from about 55:45 to about 75:25, most preferably from about 55:45 to about 65:25. In another aspect, the MMW Polymer has the Monomer 1 to Monomer 2 weight percent ratio of 80:20, more preferably 60:40.

While not being bound by theory, Applicants believe the proper selection of a MMW Polymer with a Monomer 1 to Monomer 2 weight percent % ratio as detailed in the ranges above has preferred properties of polymer charge density, adsorption, and degree of coiling to maximize performance of benefit actives.

### Cationic Vinyl Addition Monomers (Monomer 1)

Suitable cationic monomers include dialkyl ammonium halides or compounds according to formula (I):

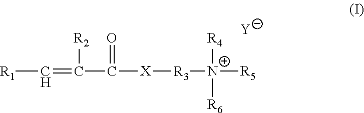

wherein:
   R₁ is from selected from hydrogen, or C₁-C₄ alkyl, and in one aspect, R₁ is hydrogen or methyl;
   R₂ is selected from hydrogen or methyl, and in one aspect, R₁ is hydrogen R₃ is selected from C₁-C₄ alkylene, and in one aspect, R₃ is ethylene;
   R₄, R₅, and R₆ are each independently selected from hydrogen, C₁-C₄ alkyl, C₁-C₄ alkyl alcohol, or C₁-C₄ alkoxy, and in one aspect, R₄, R₅, and R₆ are methyl;
   X is selected from —O—, or —NH—, and in one aspect, X is —O—; and
   Y is selected from Cl, Br, I, hydrogensulfate or methylsulfate, and in one aspect, Y is Cl.

The alkyl and alkoxy groups may be linear or branched. The alkyl groups are methyl, ethyl, propyl, butyl, and isopropyl.

In one aspect, the cationic monomer of formula (I) is dimethyl aminoethyl acrylate methyl chloride. In another aspect, the cationic monomer of formula (I) is dimethyl aminoethyl methacrylate methyl chloride. In another aspect, the cationic monomer is dialkyldimethyl ammonium chloride.

### Non-ionic Vinyl Addition Monomers (Monomer 2)

Suitable non-ionic monomers include compounds of formula (II):

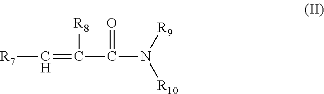

wherein:
   R₇ is selected from hydrogen or C₁-C₄ alkyl; and in one aspect R₇ is hydrogen;
   R₈ is selected from hydrogen or methyl; and in one aspect, R₈ is hydrogen; and
   R₉ and R₁₀ are each independently selected from hydrogen or C₁-C₄ alkyl, C₁-C₄ alkyl alcohol or C₁-C₄ alkoxy; and in one aspect, R₉ and R₁₀ are each independently chosen from hydrogen or methyl.

In one aspect, the non-ionic monomer is acrylamide. In another aspect, the non-ionic monomer is hydroxyethyl acrylate.

In one non-limiting example of the treatment compositions detailed herein, the MMW Polymer includes a Monomer 1 that is dimethylamino ethyl acrylate methochloride (DMA3-MeCl) and/or dimethylamino ethyl methacrylate methochloride (DMAEMA-MeCl) and a Monomer 2 that is acrylamide (AM).

In yet another aspect of said composition, the MMW Polymer, when partially hydrolyzed, contains a mixture of choline chloride and Monomer 1 consisting of dimethylamino ethyl acrylate methochloride (DMA3-MeCl) and acrylic acid (AA) in a weight percent ratio of from about 99:1 to about 10:90, preferably from about 98:2 to about 40:60, more preferably from about 97:3 to about 70:30, most preferably from about 96:4 to about 80:20. While not being bound by theory, Applicants believe choline chloride can serve as a hydrotrope to improve the dissolution of polymers in said composition.

### MMW Polymer Molecular Weight

The MMW Polymer may have a Weight Average Molecular Weight (Mw) from about from about 400,000 Daltons to about 1,800,000 Daltons, preferably from about 500,000 Daltons to about 1,500,000 Daltons, more preferably from about 550,000 Daltons to about 1,200,000 Daltons, most preferably from about 600,000 Daltons to about 850,000 Daltons.

### MMW Polymer Levels

The level of MMW Polymer in fabric treatment compositions is selected to achieve the desired properties composition, which include but are not limited to compositions with preferred a) phase stability, b) viscosity, c) freshness benefit, d) softness benefit, and e) appearance benefit. Without wishing to be bound by theory, the MMW Polymer can improve perfume system efficiency by depositing and enhancing perfume release to the headspace above the fabric, resulting in greater scent intensity and noticeability. The lack of cross-linking as well as the medium molecular weight, the MMW Polymer enables the improved release of perfume from the situs and/or from the perfume delivery technology, including but not limited to perfume microcapsules (PMC).

In addition, the preferred amounts of the MMW Polymer in the treatment compositions enable improved freshness. Selecting too low a concentration of MMW Polymer can yield minimal benefits, whereas too high a concentration of MMW Polymer can also reduce benefits. Without wishing to be bound by theory, it is believed that the targeted amount of MMW Polymer, as defined herein, improves deposition of fabric softener active (on the situs) to improve feel; and too high of a MMW Polymer concentration or too high a polymer molecular weight can lead to suppression of perfume headspace, in which perfume is not released in a timely manner, leading to less desired perfume intensity or character, and less efficient or cost-effective perfume formulations.

A preferred level of the MMW Polymer is present in the treatment compositions detailed herein from about 0.01 to about 2%, preferably from about 0.02% to about 0.5%, more preferably from about 0.03% to about 0.3%, even more preferably from about 0.04% to about 0.2%, most preferably from about 0.05% to about 0.12%.

### Fabric Softener Active

The fabric treatment composition may comprise from about 2% to about 20%, or from about 2% to about 15%, or from about 2% to about 12%, by weight of the composition, of the ester quat softening active, described in more detail below. The composition may comprise from about 2% to about 10%, preferably from about 2% to about 8%, more preferably from about 3% to about 7%, even more preferably from about 3% to about 6% by weight of the composition, of the ester quat softening active. The composition may comprise from about 2% to about 8%, by weight of the composition, of the ester quat softening active.

Suitable quaternary ammonium ester softening actives include, but are not limited to, materials selected from the group consisting of monoester quats, diester quats, triester quats and mixtures thereof. Preferably, the level of monoester quat is from 2.0% to 40.0%, the level of diester quat is from 40.0% to 98.0%, the level of triester quat is from 0.0% to 25.0% by weight of total quaternary ammonium ester softening active.

Said quaternary ammonium ester softening active may comprise compounds of the following formula:

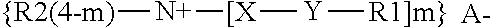

wherein:
m is 1, 2 or 3 with proviso that the value of each m is identical;
each R1 is independently hydrocarbyl, or branched hydrocarbyl group, preferably R1 is linear, more preferably R1 is partially unsaturated linear alkyl chain;
each R2 is independently a C1-C3 alkyl or hydroxyalkyl group, preferably R2 is selected from methyl, ethyl, propyl, hydroxyethyl, 2-hydroxypropyl, 1-methyl-2 hydroxyethyl, poly(C2-3¬alkoxy), polyethoxy, benzyl;
each X is independently —(CH2)n-, —CH2-CH(CH3)- or —CH(CH3)-CH2- and
each n is independently 1, 2, 3 or 4, preferably each n is 2;
each Y is independently —O—(O)C— or —C(O)—O—;
A- is independently selected from the group consisting of chloride, methyl sulfate, and ethyl sulfate, preferably A- is selected from the group consisting of chloride and methyl sulfate;
with the proviso that when Y is —O—(O)C—, the sum of carbons in each R1 is from 13 to 21, preferably from 13 to 19. Preferably, X is —CH2-CH(CH3)- or —CH(CH3)-CH2- to further improve the hydrolytic stability of the quaternary ammonium ester softening active, and hence further improve the stability of the liquid fabric treatment composition.

Because of the balance of processability and odor of the quaternary ammonium ester softening active, in preferred liquid fabric treatment compositions, the iodine value of the parent fatty acid from which the quaternary ammonium fabric softening active is formed is from 0 to 100, more preferably from 10 to 60, even more preferably from 15 to 45.

The ester quat softening actives are derived from a fatty acid feedstock. The fatty acid feedstock comprises fatty acids. The fatty acid feedstock may be partially hydrogenated, as such processes can provide the desired amount of trans fatty acids. By “partially hydrogenated” as used herein, it is meant that either the fatty acids themselves undergo a partial hydrogenation process, or that the oil from which the fatty acids are derived undergoes a hydrogenation process, or both. Additionally, partial hydrogenation processes can reduce the amount of double-unsaturated fatty acids, the presence of which may lead to color and/or odor instabilities in final product.

The fatty acids may be derived from plants. Suitable sources of plant-derived fatty acids may include vegetable oils, such as canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, and the like. Preferably, the fatty acid feedstock comprises fatty acids that are derived from cottonseed, rapeseed, sunflower seed, or soybean, preferably from cottonseed. These materials are particularly preferred because they tend to produce fatty acids having a desirable trans-unsaturation content upon partial hydrogenation. Thus, the fatty acid feedstock may comprise partially hydrogenated fatty acids derived from plants, preferably derived from vegetable oils, more preferably derived from canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, or mixtures thereof, more preferably derived from cottonseed, rapeseed, sunflower seed, soybean, or mixtures thereof. The fatty acid may comprise, at least in part, partially hydrogenated fatty acids derived from cotton seed oil, as such materials are believed to have advantageous distributions of fatty acid types and trans-unsaturated bonds.

The fatty acids may include an alkyl portion containing, on average by weight, from about 13 to about 22 carbon atoms, or from about 14 to about 20 carbon atoms, preferably from about 16 to about 18 carbon atoms, where the carbon count includes the carbon of the carboxyl group. The population of fatty acids may be present in a distribution of alkyl chains sizes. A particular fatty acid may be characterized by the number of carbons in its alkyl portion. For example, a fatty acid having sixteen carbons in the alkyl portion may be called a “C16 fatty acid.” Likewise, a fatty acid having eighteen carbons in the alkyl portion may be called a “C18 fatty acid.”

The fatty acid feedstock may comprise less than 25%, by weight of the fatty acid feedstock, of C16 fatty acids. The fatty acid feedstock may comprise from about 5% to about 25%, preferably from about 10% to about 25%, more preferably from about 15% to about 25%, even more preferably from about 20% to about 25%, by weight of the fatty acid feedstock, of C16 fatty acids. It may be desirable to limit the relative amount of C16 fatty acids in the fatty acid feedstock. Without wishing to be bound by theory, it is believed that it a relatively high proportion of C16 fatty acids (especially relative to C18 fatty acids) may lead to relatively lower viscosities in the final product.

Additionally, or alternatively, it may be desirable to have at least a certain minimum of C16 fatty acids in the fatty acid feedstock (e.g., at least 10%, preferably at least 15%, even more preferably at least 20%, by weight of the fatty acid feedstock). Such materials can help to improve processability, as esterquats based on materials that include C16 fatty acids tend to have lower melting points and may be relatively easier to disperse compared to esterquats produced primarily from the more crystalline C18 (and/or C18-trans) fatty acids with low/nil levels of C16s.

The alkyl quaternary ammonium ester softening actives may comprise compounds formed from fatty acids that are unsaturated, meaning that the fatty acids comprise at least one double bond in the alkyl portion. The fatty acids may be monounsaturated (one double bond), or they may be di-unsaturated (or double-unsaturated; two double bonds). Preferably, most of the unsaturated fatty acids in the fatty acid feedstock are monounsaturated.

The fatty acids may comprise unsaturated C18 chains, which may include a single double bond (“C18:1”) or may be double unsaturated (“C18:2”). (For reference, a fatty acid with a saturated C18 chain may be referred to as “C18:0”.) The fatty acid feedstock may comprise from about 50% to about 85%, preferably from about 60% to about 80%, more preferably from about 70% to about 80%, by weight of the fatty acid feedstock, of C18 fatty acids, regardless of saturated or unsaturated status. The fatty acid feedstock may comprise from about 20% to about 60%, preferably from about 40% to about 60%, more preferably from about 45% to about 55%, by weight of the fatty acid feedstock, of C18:0 fatty acids. The fatty acid feedstock may comprise from about 15% to about 50%, preferably from about 15% to about 30%, preferably from about 18% to about 25%, by weight of the fatty acid feedstock, of C18:1 fatty acids. The fatty acid feedstock may comprise from 0% (e.g., none) to about 20%, or from about 0% to about 15%, or from about 0% to about 10%, or from about 0% to about 5%, by weight of the fatty acid feedstock, of C18:2 fatty acids. The fatty acid feedstock may comprise from about 1% to about 15%, preferably from about 5% to about 10%, by weight of the fatty acid feedstock, of C18:2 fatty acids.

The ester quat material may be produced in a two-step synthesis process. First, an esteramine may be produced by running an esterification reaction using fatty acids and an alkanolamine. In a second step, the product may be quaternized using an alkylating agent.

The liquid fabric treatment compositions of the present disclosure may comprise other conditioning agents in addition to the ester quats described above. The other conditioning agents may be selected from the group consisting of quaternary ammonium ester compounds other than those described above, silicones, non-ester quaternary ammonium compounds, amines, fatty esters, sucrose esters, silicones, dispersible polyolefins, polysaccharides, fatty acids, softening or conditioning oils, polymer latexes, glyceride copolymers, or combinations thereof.

Examples of suitable quaternary ammonium ester softening actives are commercially available from KAO Chemicals under the trade name Tetranyl® AT-1 and Tetranyl® AT-7590, from Evonik under the tradename Rewoquat® WE16 DPG, Rewoquat® WE18, Rewoquat® WE20, Rewoquat® WE28, and Rewoquat® 38 DPG, from Stepan under the tradename Stepantex® GA90, Stepantex® VR90, Stepantex® VK90, Stepantex® VA90, Stepantex® DC90, and Stepantex® VL90A.

These types of agents and general methods of making them are disclosed in U.S. Pat. No. 4,137,180.

### Optional XL Polymer

Applicants believe the proper selection of a MMW Polymer yields a stable colloidal system comprised of linear polymers capable of entanglement. Such MMW Polymers can also interact with optional crosslinked polymers that generally cannot entangle (“XL Polymer”). The aforementioned MMW Polymer enables the colloidal system formation, the crosslinked polymers' interactions provide stability while the linear polymer allows for the desired improved efficiency of benefit actives. In the treatment compositions detailed herein, the XL Polymer is completely optional, and need not be included.

The preferred level of XL Polymer may help provide structure to the finished product. Such structure enables for example particle-based benefit actives (e.g., perfume capsules) to be suspended in the treatment composition. In addition, a preferred level of XL Polymer may help reducing the risk of product instability, which can be manifested in phase separation (a.k.a., splitting), which can lead to less preferred product aesthetics and uneven distribution of benefit actives. In addition, XL Polymer may help improving the deposition of benefit actives, leading to improved freshness and softness.

### Cross-Linking Agent for the Optional XL Polymer

The cross-linking agent contains at least two ethylenically unsaturated moieties. In one aspect, the cross-linking agent contains at least two or more ethylenically unsaturated moieties; in one aspect, the cross-linking agent contains at least three or more ethylenically unsaturated moieties.

Suitable cross-linking agents include divinyl benzene, tetraallylammonium chloride; allyl acrylates; allyl acrylates and methacrylates, diacrylates and dimethacrylates of glycols and polyglycols, allyl methacrylates; and tri- and tetramethacrylates of polyglycols; or polyol polyallyl ethers such as polyallyl sucrose or pentaerythritol triallyl ether, butadiene, 1,7-octadiene, allyl-acrylamides and allyl-methacrylamides, bisacrylamidoacetic acid, N,N′-methylene-bisacrylamide and polyol polyallylethers, such as polyallylsaccharose and pentaerythrol triallylether, ditrimethylolpropane tetraacrylate, pentaerythrityl tetraacrylate, pentaerythrityl tetraacrylate ethoxylated, pentaerythrityl tetramethacrylate, pentaerythrityl triacrylate, pentaerythrityl triacrylate ethoxylate, triethanolamine trimethacrylate, 1,1,1-trimethylolpropane triacrylate, 1,1,1-trimethylolpropane triacrylate ethoxylate, trimethylolpropane tris(polyethylene glycol ether) triacrylate, 1,1,1-trimethylolpropane trimethacrylate, tris-(2-hydroxyethyl)-1,3,5-triazine-2,4,6-trione triacrylate, tris-(2-hydroxyethyl)-1,3,5-triazine-2,4,6-trione trimethacrylate, dipentaerythrityl pentaacrylate, 3-(3-{[dimethyl-(vinyl)-silyl]-oxy}-1,1,5,5-tetramethyl-1,5-divinyl-3-trisiloxanyl)-propyl methacrylate, dipentaerythritol hexaacrylate, 1-(2-propenyloxy)-2,2-bis[(2-propenyloxy)-methyl]-butane, trimethacrylic acid-1,3,5-triazin-2,4,6-triyltri-2,1-ethandiyl ester, glycerine triacrylate propoxylate, 1,3,5-triacryloylhexahydro-1,3,5-triazine, 1,3-dimethyl-1,1,3,3-tetravinyldisiloxane, pentaerythrityl tetravinyl ether, 1,3-dimethyl-1,1,3,3-tetravinyldisiloxane, (Ethoxy)-trivinylsilane, (Methyl)-trivinylsilane, 1,1,3,5,5-pentamethyl-1,3,5-trivinyltrisiloxane, 1,3,5-trimethyl-1,3,5-trivinylcyclotrisilazane, 2,4,6-trimethyl-2,4,6-trivinylcyclotrisiloxane, 1,3,5-trimethyl-1,3,5-trivinyltrisilazane, tris-(2-butanone oxime)-vinylsilane, 1,2,4-trivinylcyclohexane, trivinylphosphine, trivinylsilane, methyltriallylsilane, pentaerythrityl triallyl ether, phenyltriallylsilane, triallylamine, triallyl citrate, triallyl phosphate, triallylphosphine, triallyl phosphite, triallylsilane, 1,3,5-triallyl-1,3,5-triazine-2,4,6(1H,3H,5H)-trione, trimellitic acid triallyl ester, trimethallyl isocyanurate, 2,4,6-tris-(allyloxy)-1,3,5-triazine, 1,2-Bis-(diallylamino)-ethane, pentaerythrityl tetratallate, 1,3,5,7-tetravinyl-1,3,5,7-tetramethylcyclotetrasiloxane, 1,3,5,7-tetravinyl-1,3,5,7-tetramethylcyclotetrasiloxane, tris-[(2-acryloyloxy)-ethyl]-phosphate, vinylboronic anhydride pyridine, 2,4,6-trivinylcyclotriboroxanepyridine, tetraallylsilane, tetraallyloxysilane, 1,3,5,7-tetramethyl-1,3,5,7-tetravinylcyclotetrasilazane. Preferred compounds includealkyltrimethylammonium chloride, pentaerythrityl triacrylate, pentaerythrityl tetraacrylate, tetrallylammonium chloride, 1,1,1-trimethylolpropane tri(meth)acrylate, or a mixture thereof. These preferred compounds can also be ethoxylated and mixtures thereof. In one aspect, the cross-linking agents are chosen from tetraallyl ammonium chloride, allyl-acrylamides and allyl-methacrylamides, bisacrylamidoacetic acid, and N,N′-methylene-bisacrylamide, and mixtures thereof. In one aspect, the cross-linking agent is tetraallyl ammonium chloride. In another aspect, the cross-linking agent is a mixture of pentaerythrityl triacrylate and pentaerythrityl tetraacrylate.

For the XL Polymer, the crosslinker(s) may be included in the range of from about 45 ppm to about 5,000 ppm, alternatively from about 50 ppm to about 500 ppm; alternatively, from about 100 ppm to about 400 ppm, alternatively from about 500 ppm to about 4,500 ppm, alternatively from about 550 ppm to about 4,000 ppm based on the weight of the polymer.

### Chain Transfer Agent for Polymers

For the XL Polymer, the chain transfer agent (“CTA”) may include mercaptans, malic acid, lactic acid, formic acid, isopropanol and hypophosphites, and mixtures thereof. In one aspect, the CTA is formic acid.

The CTA may be present in a range greater than about 100 ppm based on the weight of the polymer. In one aspect, the CTA may be present from about 100 ppm to about 10,000 ppm, alternatively from about 500 ppm to about 4,000 ppm, alternatively from about 1,000 ppm to about 3,500 ppm, alternatively from about 1,500 ppm to about 3,000 ppm, alternatively from about 1,500 ppm to about 2,500 ppm, alternatively combinations thereof based on the weight of the polymer. In yet another aspect, the CTA may be greater than about 1,000 based on the weight of the polymer. It is also suitable to use mixtures of chain transfer agents.

### XL Polymer Level

In exemplary treatment compositions, XL Polymer may be present in an amount from about 0.02% to about 1%, preferably from about 0.03% to about 0.4%, more preferably from about 0.04% to about 0.25%, even more preferably from about 0.05% to about 0.15% most preferably from about 0.06% to about 0.10%. However, in one aspect when the softener active level is less than about 6% by weight of the treatment composition, a preferred level of XL Polymer is from about 0.1% to about 0.3%, and wherein the softener active level is greater than about 6% by weight of treatment composition, a preferred level of XL Polymer is from about 0.04% to about 0.2%.

### Ratio of MMW Polymer to Optional XL Polymer

The ratio of MMW Polymer to XL Polymer in finished product (FP) may be selected to achieve the desired properties of the treatment composition, which include those described for MMW Polymer and XL Polymer above. It was surprisingly found that selecting too low a ratio of MMW Polymer to XL Polymer can reduce the softness and freshness benefits and risk undesired treatment composition viscosity, whereas selecting too high a ratio of MMW Polymer to XL Polymer can risk poor FP stability. For example, in one embodiment the ratio of MMW Polymer to XL Polymer is from about 1:6 to about 6:1, preferably about 1:3 to about 3:1, even more preferably about 1:2 to about 2:1, most preferably from about 2:3 to 3:2.

### XL Polymer Molecular Weight

In another aspect, XL Polymer may have a Weight Average Molecular Weight (Mw) from about 1,200,000 Daltons to about 6,000,000 Daltons, preferably from about 1,500,000 Daltons to about 5,0000,000 Daltons, more preferably from about 1,800,000 to 4,000,000 Daltons.

XL Polymer may consist of a fraction of less cross-linked and a fraction of more cross-linked polymer. In one embodiment, XL Polymer may have a weight percent of a less cross-linked fraction of from about 0% to 60%, preferably from 10% to 40%, most preferably from 25% to 35%. In another embodiment, XL Polymer may have a weight percent of less cross-linked fraction of from 0% to 25%, preferably from about 0.01% to 10%, more preferably from 0.01% to 5%, even more preferably from 0.01% to 1%, most preferably from 0% to 0.1%.

In another embodiment, XL Polymer may have a weight percent of a less cross-linked fraction of from 5% to 25%. Without being bound by theory, the Weight Average Molecular Weights (Mw) of the less cross-linked and the more cross-linked fractions of XL Polymer may be similar (i.e., both are within the Mw range for XL Polymer).

In still another embodiment, XL Polymer may have a Weight Average Molecular Weight (Mw) from about 5 times to about 80 times the Weight Average Molecular Weight (Mw) of LMW Polymer, preferably from about 15 times to about 50 times, more preferably from about 20 times to about 30 times, wherein LMW Polymer comprises a Weight Average Molecular Weight (Mw) from about 90,000 Daltons to about 300,000 Daltons.

In still another embodiment, XL Polymer may have a Weight Average Molecular Weight (Mw) from about 3 times to about 40 times the Weight Average Molecular Weight (Mw) of MMW Polymer, preferably from about 4 times to about 20 times, more preferably from about 5 times to about 15 times, wherein MMW Polymer may have a Weight Average Molecular Weight (Mw) from about 400,000 Daltons to about 1,800,000 Daltons, preferably from about 400,000 Daltons to about 1,800,000 Daltons.

In one embodiment, XL Polymer may consist of a fraction of less cross-linked and a fraction of more cross-linked polymers. In one embodiment, XL Polymer has a weight percent of a less cross-linked fraction of from about 0.1% to 80%, preferably from about 1% to 60%, more preferably from 10% to 40%, most preferably from 25% to 35%.

In another embodiment, XL Polymer may consist of a fraction of less cross-linked and a fraction of more cross-linked polymers. In one embodiment, XL Polymer has a weight percent of a less cross-linked fraction to more cross-linked fraction of from about 0% to 30%, preferably from about 0.01% to 10%, more preferably from 0.05% to 5%, most preferably from 0.1% to 1%.

Without being bound by theory, the Weight Average Molecular Weights (Mw) of the less cross-linked XL Polymer fractions and the more cross-linked XL Polymer fractions are similar (i.e., both are within the Mw range for XL Polymer).

### Perfume and Perfume Delivery Systems

The liquid fabric treatment compositions may comprise perfume, a perfume delivery system, or a combination thereof. Such systems may improve the freshness performance of the compositions described herein. In particular, perfume delivery systems may facilitate improved freshness performance by increasing deposition efficiency, facilitating perfume release at different touchpoints, and/or increasing longevity of perfume performance.

### Neat Perfume

Perfume may be present as neat oil, sometimes referred to as, for example, “free” perfume, unencapsulated perfume, or free perfume oil. The liquid fabric treatment compositions may comprise from about 0.01% to about 5%, or from about 0.05% to about 4%, or from about 0.1% to about 3%, or from about 0.5% to about 2%, by weight of the composition, or free perfume oil.

Neat oil can comprise perfume raw materials such as 3-(4-t-butylphenyl)-2-methyl propanal, 3-(4-t-butylphenyl)-propanal, 3-(4-isopropylphenyl)-2-methylpropanal, 3-(3,4-methylenedioxyphenyl)-2-methylpropanal, and 2,6-dimethyl-5-heptenal, alpha-damascone, beta-damascone, gamma-damascone, beta-damascenone, 6,7-dihydro-1,1,2,3,3-pentamethyl-4(5H)-indanone, methyl-7,3-dihydro-2H-1,5-benzodioxepine-3-one, 2-[2-(4-methyl-3-cyclohexenyl-1-yl)propyl]cyclopentan-2-one, 2-sec-butylcyclohexanone, and beta-dihydro ionone, linalool, ethyllinalool, tetrahydrolinalool, and dihydromyrcenol; silicone oils, waxes such as polyethylene waxes; essential oils such as fish oils, jasmine, camphor, lavender; skin coolants such as menthol, methyl lactate; vitamins such as Vitamin A and E; sunscreens; glycerine; catalysts such as manganese catalysts or bleach catalysts; bleach particles such as perborates; silicon dioxide particles; antiperspirant actives; cationic polymers and mixtures thereof. Suitable benefit agents can be obtained from Givaudan Corp. of Mount Olive, New Jersey, USA, International Flavors & Fragrances Corp. of South Brunswick, New Jersey, USA, or Firmenich Company of Geneva, Switzerland or Encapsys Company of Appleton, Wisconsin (USA). As used herein, a “perfume raw material” refers to one or more of the following ingredients: fragrant essential oils; aroma compounds; pro-perfumes; materials supplied with the fragrant essential oils, aroma compounds, and/or pro-perfumes, including stabilizers, diluents, processing agents, and contaminants; and any material that commonly accompanies fragrant essential oils, aroma compounds, and/or pro-perfumes.

### Perfume Delivery Systems

The perfume delivery system may comprise perfume capsules, for example, where a core is surrounded by wall material (“core-shell encapsulates”); the core may comprise perfume and optionally a partitioning modifier (e.g., isopropyl myristate). The wall material may include melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, or mixtures thereof. The melamine wall material may comprise melamine crosslinked with formaldehyde, melamine-dimethoxyethanol crosslinked with formaldehyde, and mixtures thereof; encapsulates with such wall materials may be used in combination with a formaldehyde scavenger, such as acetoacetamide, urea, or derivatives thereof. The polyacrylate based wall materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof.

The polyacrylate ester-based wall materials may comprise polyacrylate esters formed by alkyl and/or glycidyl esters of acrylic acid and/or methacrylic acid, acrylic acid esters and/or methacrylic acid esters which carry hydroxyl and/or carboxy groups, and allylgluconamide, and mixtures thereof.

The aromatic alcohol-based wall material may comprise aryloxyalkanols, arylalkanols and oligoalkanolarylethers. It may also comprise aromatic compounds with at least one free hydroxyl-group, especially preferred at least two free hydroxy groups that are directly aromatically coupled, wherein it is especially preferred if at least two free hydroxy-groups are coupled directly to an aromatic ring, and more especially preferred, positioned relative to each other in meta position. It is preferred that the aromatic alcohols are selected from phenols, cresoles (o-, m-, and p-cresol), naphthols (alpha and beta-naphthol) and thymol, as well as ethylphenols, propylphenols, fluorophenols and methoxyphenols.

The polyurea based wall material may comprise a polyisocyanate. The shell of the perfume capsules may comprise a polymeric material that may be the reaction product of a polyisocyanate and a chitosan. The shell may comprise a polyurea resin, where the polyurea resin comprises the reaction product of a polyisocyanate and chitosan. The perfume capsules of the present disclosure may be considered perfume capsules and include a polyurea-chitosan shell. (As used herein, “shell” and “wall” are used interchangeably with regard to the perfume capsules, unless indicated otherwise.) The shell may be derived from isocyanates and chitosan.

The polyisocyanate may be an aliphatic or aromatic monomer, oligomer or prepolymer, usefully comprising two or more isocyanate functional groups. The polyisocyanate may preferably be selected from a group comprising toluene diisocyanate, a trimethylol propane adduct of toluene diisocyanate and a trimethylol propane adduct of xylylene diisocyanate, methylene diphenyl isocyanate, toluene diisocyanate, tetramethylxylidene diisocyanate, naphthalene-1,5-diisocyanate, and phenylene diisocyanate.

The composition may comprise from about 0.05% to about 20%, or from about 0.05% to about 10%, or from about 0.1% to about 5%, or from about 0.2% to about 2%, by weight of the composition, of perfume capsules. The composition may comprise a sufficient amount of perfume capsules to provide from about 0.05% to about 10%, or from about 0.1% to about 5%, or from about 0.1% to about 2%, by weight of the composition, of the encapsulated benefit agent, which may preferably be perfume raw materials, to the composition. When discussing herein the amount or weight percentage of the perfume capsules, it is meant the sum of the wall material and the core material.

The perfume capsules according to the present disclosure may be characterized by a volume-weighted median particle size from about 1 to about 100 microns, preferably from about 10 to about 100 microns, preferably from about 15 to about 50 microns, more preferably from about 20 to about 40 microns, even more preferably from about 20 to about 30 microns. Different particle sizes are obtainable by controlling droplet size during emulsification.

The perfume capsules may be characterized by a ratio of core to shell up to 99:1, or even 99.5:1, on the basis of weight.

The encapsulates may be coated with a deposition aid, a cationic polymer, a non-ionic polymer, an anionic polymer, or mixtures thereof. Suitable polymers may be selected from the group consisting of: polyvinylformaldehyde, partially hydroxylated polyvinylformaldehyde, polyvinylamine, polyethyleneimine, ethoxylated polyethyleneimine, polyvinylalcohol, polyacrylates, a polysaccharide (e.g., chitosan), and combinations thereof.

The perfume delivery system may comprise a pro-perfume, for example a siloxane-based pro-perfume, where a perfume raw material is associated with (for example, via covalent bonding) a polymer (e.g., a siloxane polymer) upon delivery to a surface and is released upon or after treatment of a surface with the composition.

### Adjunct Materials

While not essential for the purposes of the present invention, the non-limiting list of adjuncts illustrated hereinafter are suitable for use in the instant compositions and may be desirably incorporated in certain aspects of the invention, for example to assist or enhance cleaning performance, for treatment of the substrate to be cleaned, or to modify the aesthetics of the composition as is the case with perfumes, colorants, dyes or the like. The precise nature of these additional components, and levels of incorporation thereof, will depend on the physical form of the composition and the nature of the fabric treatment operation for which it is to be used. Suitable adjunct materials include, but are not limited to, surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, hueing dyes, perfumes, perfume delivery systems, structure elasticizing agents, carriers, structurants, hydrotropes, processing aids, solvents and/or pigments.

As stated, the adjunct ingredients are not essential to Applicants' compositions. Thus, certain aspects of Applicants' compositions do not contain one or more of the following adjuncts materials: surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, hueing dyes, perfumes, perfume delivery systems structure elasticizing agents, carriers, hydrotropes, processing aids, solvents and/or pigments. However, when one or more adjuncts are present, such one or more adjuncts may be present as detailed below.

Surfactants—The compositions according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof.

The surfactant is typically present at a level of from about 0.01% to about 60%, from about 0.1% to about 60%, from about 1% to about 50% or even from about 5% to about 40% by weight of the subject composition. Alternatively, the surfactant may be present at a level of from about 0.01% to about 60%, from about 0.01% to about 50%, from about 0.01% to about 40%, from about 0.1% to about 25%, from about 1% to about 10%, by weight of the subject composition.

Chelating Agents—The compositions herein may contain a chelating agent. Suitable chelating agents include copper, iron and/or manganese chelating agents and mixtures thereof. When a chelating agent is used, the composition may comprise from about 0.1% to about 15% or even from about 3.0% to about 10% chelating agent by weight of the subject composition.

Dye Transfer Inhibiting Agents—The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof.

When present in a subject composition, the dye transfer inhibiting agents may be present at levels from about 0.0001% to about 10%, from about 0.01% to about 5% or even from about 0.1% to about 3% by weight of the composition.

Dispersants—The compositions of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

### Processes of Making Products

The compositions of the present invention can be formulated into any suitable form and prepared by any process chosen by the formulator, non-limiting examples of which are described in Applicants examples and in US 2013/0109612 A1 which is incorporated herein by reference.

In one aspect, the compositions disclosed herein may be prepared by combining the components thereof in any convenient order and by mixing, e.g., agitating, the resulting component combination to form a phase stable fabric and/or home care composition. In one aspect, a fluid matrix may be formed containing at least a major proportion, or even substantially all, of the fluid components with the fluid components being thoroughly admixed by imparting shear agitation to this liquid combination. For example, rapid stirring with a mechanical stirrer may be employed.

### Method of Use

The compositions of the present invention may be used in any conventional manner. In short, they may be used in the same manner as products that are designed and produced by conventional methods and processes. For example, compositions of the present invention can be used to treat a situs inter alia a surface or fabric. Typically, at least a portion of the situs is contacted with an aspect of Applicants' composition, in neat form or diluted in a wash liquor, and then the situs is optionally washed and/or rinsed. For purposes of the present invention, washing includes but is not limited to, scrubbing, and mechanical agitation. The fabric may comprise any fabric capable of being laundered in normal consumer use conditions. When the wash solvent is water, the water temperature typically ranges from about 5° C. to about 90° C. and, when the situs comprises a fabric, the water to fabric mass ratio is typically from about 1:1 to about 100:1.

The consumer products of the present invention may be used as liquid fabric treatment compositions wherein they are applied to a fabric and the fabric is then dried via line drying and/or drying with an automatic dryer.

Preferably, said composition that comprises a fabric softener active, and a cationic polymer is a composition disclosed and/or claimed in the present specification. In one aspect, said liquor may comprise an anionic surfactant, preferably 1 ppm to 1000 ppm, more preferably 1 ppm to 100 ppm of an anionic surfactant is disclosed.

### Test Methods

### Brookfield Viscosity

Brookfield viscosity is measured using a Brookfield DV-E viscometer. The liquid is contained in a glass jar, where the width of the glass jar is from about 5.5 to 6.5 cm and the height of the glass jar is from about 9 to about 11 cm. For viscosities below 500 cPs, use spindle LV2 at 60 RPM, and to measure viscosities from 500 to 2,000 cPs, use spindle LV3 at 60 RPM. The test is conducted in accordance with the instrument's instructions. Initial Brookfield viscosity is defined as the Brookfield viscosity measured within 24 hours of making the subject composition.

### Physical Stability

Physical stability is assessed by visual observation of the product in an undisturbed glass jar, where the width of the glass jar is from about 5.5 to 6.5 cm and the height of the glass jar is from about 9 to about 11 cm, after a set period. Using a ruler with millimeter graduation, the height of the liquid in the jar and the height of any visually observed phase separation are measured. The Stability Index is defined as the height of the phase split divided by the height of the liquid in the glass jar. A product with no visually observable phase split is given a stability index of zero.

### Measurement of Weight Average Molecular Weight (Mw) MMW Polymer

The weight average molecular weights of the cationic polymers of the present invention are determined by the technique of Size Exclusion Chromatography (SEC). SEC separation is carried out under conditions including three hydrophilic vinyl polymer network Novema gel columns, in distilled water ion the presence of 0.1% (w/w) trifluoroacetate and 0.1 M NaCl at 35° C. Calibration is conducted with narrowly distributed poly(2-vinylpyridine)-standard of company PSS, Deutschland with molecular weights Mw=839 to M=2.070.000.

### Perfume Release Headspace Over Fabric Measurement Method

Fabrics were treated with compositions of the current invention using the Fabric Preparation method described within. The perfume release over fabric data was generated using standard dynamic purge and trap analysis of fabric headspace with gas chromatography (GC) and detector to measure perfume headspace levels. The headspace analysis was performed on wet and dry fabric and total perfume counts were normalized to one of the test legs to show the relative benefit of compositions of the present invention. For example, a dry fabric perfume headspace (normalized to 1.0) shows that Leg C has 50% more perfume headspace above the wet fabric than Leg A.

### GC—Detector Analysis of Fabric Samples for Perfume Release:

Approximately 1.2 g of test fabrics are placed into a 20 mL headspace sample vial (#23082, available from Restek, Bellefonte, PA), and the vial is capped (#093640-040-00 available from Gerstel, Linthicum, MD). Dry fabrics are equilibrated for 4 hours in a constant temperature and humidity room at 21 C and 50% RH prior to capping. The fabric pieces are cut from different fabrics within each wash load to account for fabric-to-fabric variability. Instrument conditions should be modified to achieve adequate PRM signal detection while avoiding peak saturation. The sample vials are then loaded onto a Gerstel MPS2 Autosampler (Gerstel Inc., Linthicum, MD, USA). Prior to the headspace analysis, each sample is pre-conditioned in the machine at 65° C. for 10 minutes. Headspace is extracted onto an Agilent 7890B/5977A GC-MS system (Agilent Technologies, Santa Clara, CA, USA) equipped with a Supelco 50/30 micrometer DVB/CAR/PDMS 23Ga. Solid Phase Micro Extraction fiber (Supelco Inc., Bellefonte, PA, USA). GC analysis is conducted on a non-polar capillary column (DB-5MS UI, 30 meters nominal diameter, 0.25 millimeter nominal diameter, 25 micrometer thickness) and the headspace constituents (i.e. the perfume raw materials) are monitored by Mass Spectrometry (EI, 70 eV detector).

### COMBINATIONS

Specifically contemplated combinations of the disclosure are herein described in the following lettered paragraphs. These combinations are intended to be illustrative in nature and are not intended to be limiting.
A. A liquid fabric treatment composition comprising, based upon total composition weight, from about 0.01% to about 2% of a MMW polymer derived from the polymerization of from about 5 to 100 mole percent of a cationic vinyl addition monomer, from about 0 to 95 mole percent of a non-ionic vinyl addition monomer, wherein the molecular weight of the MMW polymer is from about 400,000 to about 1,800,000 Daltons, and from about 1% to about 25% of a fabric softener active material.
B. The liquid fabric treatment composition of paragraph A, wherein the MMW polymer is a linear polymer, having not been made in the presence of a cross-linker.
C. The liquid fabric treatment composition of any of paragraphs A-B, wherein the molecular weight of the MMW polymer is from about 550,000 to about 1,200,000 Daltons.
D. The liquid fabric treatment composition of any of paragraphs A-C, wherein the molecular weight of the MMW polymer is from about 600,000 to about 850,000 Daltons.
E. The liquid fabric treatment composition of any of paragraphs A-D, wherein the composition comprises, based upon total composition weight, about 0.02% to about 0.5%, of MMW polymer.
F. The liquid fabric treatment composition of any of paragraphs A-E, wherein the composition comprises, based upon total composition weight, about 0.04% to about 0.25%, of MMW polymer.
G. The liquid fabric treatment composition of any of paragraphs A-F, wherein the composition comprises, based upon total composition weight, about 0.05% to about 0.15%, of MMW polymer.
H. The liquid fabric treatment composition of any of paragraphs A-G, wherein the composition comprises, based upon total composition weight, about 0.05% to about 0.12%, of MMW polymer.
I. The liquid fabric treatment composition of any of paragraphs A-H, further comprising an XL polymer, wherein the molecular weight of the XL polymer is from about 1,200,000 to about 6,000,000 Daltons.
J. The liquid fabric treatment composition of paragraph I, wherein the composition comprises, based upon total composition weight, about 0.02% to about 1%, of XL polymer.
K. The liquid fabric treatment composition of any of paragraphs I-J, wherein the composition comprises, based upon total composition weight, about 0.03% to about 0.4%, of XL polymer.
L. The liquid fabric treatment composition of any of paragraphs I-K, wherein the composition comprises, based upon total composition weight, about 0.04% to about 0.25%, of XL polymer.
M. The liquid fabric treatment composition of any of paragraphs I-L, wherein the composition comprises, based upon total composition weight, about 0.05% to about 0.15%, of XL polymer.
N. The liquid fabric treatment composition of any of paragraphs I-M, wherein the composition comprises, based upon total composition weight, about 0.06% to about 0.10%, of XL polymer.
O. The liquid fabric treatment composition of any of paragraphs I-N, wherein the molecular weight of the XL polymer is from about 1,500,000 to about 5,000,000 Daltons.
P. The liquid fabric treatment composition of any of paragraphs I-O, wherein the molecular weight of the XL polymer is from about 1,800,000 to about 4,000,000 Daltons.
Q. The liquid fabric treatment composition of any of paragraphs I-P, wherein the ratio of weight of XL polymer to MMW polymer is from about 1:5 to about 5:1.
R. The liquid fabric treatment composition of any of paragraphs I-Q, wherein the ratio of weight of XL polymer to MMW polymer is from about 1:3 to about 3:1.
S. The liquid fabric treatment composition of any of paragraphs I-R, wherein the ratio of weight of XL polymer to MMW polymer is from about 1:2 to about 2:1.
T. The liquid fabric treatment composition of any of paragraphs I-S, wherein the composition comprises from about 3% to about 20% of the fabric softener active material.

### EXAMPLES

TABLE 1
Non-limiting examples of LMW Polymers, MMW Polymers, and XL Polymers

| | | | Monomer 1 | Monomer 2 | Cross- | |
|---|---|---|---|---|---|---|
| Polymer | Monomer 1 | Monomer 2 | (wt. %) | (wt. %) | linked? | MW (kDal) |
| P1.1 | DMA3-MeCl | AM | 80 | 20 | No | 275 |
| P1.2 | DMA3-MeCl | AM | 80 | 20 | No | 200 |
| P1.3 | DMA3-MeCl | AM | 80 | 20 | No | 150 |
| P1.4 | DMA3-MeCl | AM | 80 | 20 | No | 100 |
| P1.5 | DMA3-MeCl | AM | 60 | 40 | No | 210 |
| P1.6 | DMA3-MeCl | AM | 50 | 50 | No | 125 |
| P1.7 | DMA3-MeCl | AM | 90 | 10 | No | 175 |
| P1.8 | DMA3-MeCl | AM | 95 | 5 | No | 200 |
| P1.9 | DMA3-MeCl | — | 100 | — | No | 150 |
| P1.10 | DMAEMA-MeCl | AM | 80 | 20 | No | 250 |
| P1.11 | DMAEMA-MeCl | AM | 80 | 20 | No | 150 |
| P1.12 | DMAEMA-MeCl | AA | 80 | 20 | No | 125 |
| P2.1 | DMA3-MeCl | AM | 60 | 40 | No | 725 |
| P2.2 | DMA3-MeCl | AM | 60 | 40 | No | 650 |
| P2.3 | DMA3-MeCl | AM | 60 | 40 | No | 1100 |
| P2.4 | DMA3-MeCl | AM | 80 | 20 | No | 725 |
| P2.5 | DMA3-MeCl | AM | 80 | 20 | No | 450 |
| P2.6 | DMA3-MeCl | AM | 90 | 10 | No | 725 |
| P2.7 | DMA3-MeCl | — | 100 | 0 | No | 725 |
| P2.8 | DADMAC | AM | 80 | 20 | No | 700 |
| P2.9 | DADMAC | AA | 80 | 20 | No | 550 |
| P3.1 | DMAEMA-MeCl | AM | 90 | 10 | Yes | >2,000 |
| P3.2 | DMAEMA-MeCl | AM | 80 | 20 | Yes | >2,000 |
| P3.3 | DMAEMA-MeCl | AM | 90 | 10 | Yes | >2,000 |
| P3.4 | DMAEMA-MeCl | — | 100 | 0 | Yes | >2,000 |
| P3.5 | DMA3-MeCl | AM | 90 | 10 | Yes | >2,000 |
| P3.6 | DMA3-MeCl | AM | 80 | 20 | Yes | >2,000 |
| P3.7 | DMA3-MeCl | AM | 60 | 40 | Yes | >2,000 |
| P3.8 | DMA3-MeCl | — | 100 | 0 | Yes | >2,000 |

DimethylAmino Ethyl Acrylate methochloride is “DMA3-MeCl”
DimethylAmino Ethyl MethAcrylate methochloride is “DMAEMA-MeCl”
Acrylamide is “AM”
Acrylic Acid is “AA”
Diallyldimethyl ammonium chloride is “DADMAC”

Nonlimiting examples of LMW Polymers are P1.1 to P1.12. The LMW Polymers used in the comparative examples herein are derived from the same polymerization as described herein for MMW Polymers, and are the same in all aspects except for molecular weight. The LMW Polymers used herein have a molecular weight of between about 40,000 Daltons and about 250,000 Daltons.
Nonlimiting examples of MMW Polymers are P2.1 to P2.9
Nonlimiting examples of XL Polymers are P3.1 to P3.8

### Example 1: Ingredient Amounts Provided in Wt %, Unless Otherwise Indicated

| | F1 | |
|---|---|---|
| Formula | (Comparative) | F2 |
| FSA ^{a} | 7.5 | 7.5 |
| LMW Polymer ^{b} | 0.10 | — |
| MMW Polymer ^{c} | — | 0.10 |
| XL Polymer ^{d} | 0 | 0 |
| Perfume Encapsulate (PAC) ^{f} | 0.21 | 0.21 |
| Perfume Encapsulate (MF) ^{g} | 0.13 | 0.13 |
| Perfume Oil | 0 | 0 |
| Minors and Deionized Water | Balance | Balance |
| Encapsulate (PAC) Headspace ^{h} | 1.00 | 1.12 |
| Encapsulate (MF) Headspace ^{h} | 1.00 | 1.26 |
| Viscosity @ 1 Week (cps) | 51 | 86 |
| % Phase Instability @ 1 Week (23° C.) | 20 | 0 |

^{a} Fabric Softener Active (FSA) = N,N-di(alkanoyloxyethyl)-N,N-dimethylammonium chloride where alkyl consists predominantly of C16-C18 alkyl chains with an IV value of about 20 available from Evonik Industries.
^{b} LMW Polymer (P1.5 from Table 1): Dimethylamino Ethyl Acrylate methochloride (DMA3-MeCl) + Acrylamide (AM) in a 60:40 wt ratio, respectively, with an average molecular weight of about 210 kDal.
^{c} MMW Polymer (P2.1 from Table 1): Dimethylamino Ethyl Acrylate methochloride (DMA3-MeCl) + Acrylamide (AM) in a 60:40 wt ratio, respectively, with an average molecular weight of about 725 kDal.
^{d} XL Polymer (P3.1 from Table 1): DimethylAmino Ethyl MethAcrylate methochloride (DMAEMA-MeCl) + Acrylamide (AM) in a 90:10 wt ratio, respectively, with an average molecular weight of more than 2,000 kDal. (i.e., Flosoft FS2220 is available from SNF Floerger).
^{f} Polyacrylate (PAC) perfume microcapsules (PMCs) from Appleton Papers, Inc.
^{g} Melamine Formaldehyde (MF) perfume microcapsules (PMCs) from Appleton Papers, Inc.
^{h} Headspace (HS) values (nM/L) normalized to 1.00.

### Example 2: Ingredient Amounts are Provided in Wt %, Unless Otherwise Indicated

| | F3 | | | |
|---|---|---|---|---|
| Formula | (Comparative) | F4 | F5 | F6 |
| FSA ^{a} | 9.7 | 9.7 | 9.7 | 9.7 |
| LMW Polymer ^{b} | 0.20 | — | 0.10 | — |
| MMW Polymer ^{c} | — | 0.10 | 0.10 | 0.20 |
| XL Polymer ^{d} | 0.20 | 0.20 | 0.20 | 0.20 |
| Perfume Encapsulate | 0.21 | 0.21 | 0.21 | 0.21 |
| (PAC) ^{f} | | | | |
| Perfume Encapsulate | 0.13 | 0.13 | 0.13 | 0.13 |
| (MF) ^{g} | | | | |
| Perfume Oil | 0.60 | 0.60 | 0.60 | 0.60 |
| Minors and Deionized | Balance | Balance | Balance | Balance |
| Water | | | | |
| FSA Deposition on Fabric | 5130 | 5202 | 5428 | 6049 |
| (ug/g) | | | | |

^{a} Fabric Softener Active (FSA) = N,N-di(alkanoyloxyethyl)-N,N-dimethylammonium chloride where alkyl consists predominantly of C16-C18 alkyl chains with an IV value of about 20 available from Evonik Industries.
^{b} LMW Polymer (P1.2 from Table 1): Dimethylamino Ethyl Acrylate methochloride (DMA3-MeCl) + Acrylamide (AM) in an 80:20 wt ratio, respectively, with an average molecular weight of about 200 kDal.
^{c} MMW Polymer (P2.4 from Table 1): Dimethylamino Ethyl Acrylate methochloride (DMA3-MeCl) + Acrylamide (AM) in an 80:20 wt ratio, respectively, with an average molecular weight of about 725 kDal.
^{d} XL Polymer (P3.1 from Table 1): DimethylAmino Ethyl MethAcrylate methochloride (DMAEMA-MeCl) + Acrylamide (AM) in a 90:10 wt ratio, respectively, with an average molecular weight of more than 2,000 kDal. (i.e., Flosoft FS222@ is available from SNF Floerger).
^{f} Polyacrylate (PAC) perfume microcapsules (PMCs) from Appleton Papers, Inc.
^{g} Melamine Formaldehyde (MF) perfume microcapsules (PMCs) from Appleton Papers, Inc.

### Example 3: Ingredient Amounts Provided in Wt %, Unless Otherwise Indicated

| | F7 | |
|---|---|---|
| Formula | (Comparative) | F8 |
| FSA ^{a} | 4.0 | 4.0 |
| LMW Polymer ^{b} | 0.30 | — |
| MMW Polymer ^{c} | — | 0.30 |
| XL Polymer ^{d} | 0.20 | 0.20 |
| Perfume Encapsulate (PAC) ^{f} | 0.21 | 0.21 |
| Perfume Encapsulate (MF) ^{g} | 0.13 | 0.13 |
| Perfume Oil | 0 | 0 |
| Minors and Deionized Water | Balance | Balance |
| Perfume Encapsulate (PAC) Headspace ^{h} | 1.00 | 1.02 |
| Viscosity (cP) @ 1 Week | 87 | 150 |
| Phase Instability (%) @ 3 Months | 0 | 0 |

^{a} Fabric Softener Active (FSA) = N, N-di(alkanoyloxyethyl)-N,N-dimethylammonium chloride where alkyl consists predominantly of C16-C18 alkyl chains with an IV value of about 20 available from Evonik Industries.
^{b} LMW Polymer (P1.5 from Table 1): Dimethylamino Ethyl Acrylate methochloride (DMA3-MeCl) + Acrylamide (AM) in a 60:40 wt ratio, respectively, with an average molecular weight of about 210 kDal.
^{c} MMW Polymer (P2.1 from Table 1): Dimethylamino Ethyl Acrylate methochloride (DMA3-MeCl) + Acrylamide (AM) in a 60:40 wt ratio, respectively, with an average molecular weight of about 725 kDal.
^{d} XL Polymer (P3.1 from Table 1): DimethylAmino Ethyl MethAcrylate methochloride (DMAEMA-MeCl) + Acrylamide (AM) in a 90:10 wt ratio, respectively, with an average molecular weight of more than 2,000 kDal. (i.e., Flosoft FS222@ is available from SNF Floerger).
^{f} Polyacrylate (PAC) perfume microcapsules (PMCs) from Appleton Papers, Inc.
^{g} Melamine Formaldehyde (MF) perfume microcapsules (PMCs) from Appleton Papers, Inc.
^{h} Headspace (HS) values (nM/L) normalized to 1.00.

### Example 4: Ingredient Amounts Provided in Wt %, Unless Otherwise Indicated

| | F9 | | | F12 | | |
|---|---|---|---|---|---|---|
| Formula | (Comparative) | F10 | F11 | (Comparative) | F13 | F14 |
| FSA ^{a} | 7.5 | 7.5 | 7.5 | 9.7 | 9.7 | 9.7 |
| LMW Polymer ^{b} | 0.04 | — | — | 0.04 | — | — |
| MMW Polymer ^{c1} | — | 0.2 | — | — | 0.2 | — |
| MMW Polymer ^{c2} | — | — | 0.2 | — | — | 0.2 |
| XL Polymer ^{d} | — | 0.2 | 0.2 | — | 0.2 | 0.2 |
| XL Polymer ^{e} | 0.12 | — | — | 0.12 | — | — |
| Perfume Encapsulate (PAC) ^{f} | 0.21 | 0.21 | 0.21 | 0.21 | 0.21 | 0.21 |
| Perfume Encapsulate (MF) ^{g} | 0.13 | 0.13 | 0.13 | 0.13 | 0.13 | 0.13 |
| Perfume Oil | 0.60 | 0.60 | 0.60 | 0.60 | 0.60 | 0.60 |
| Minors and Deionized Water | Balance | Balance | Balance | Balance | Balance | Balance |
| FSA Deposition on Fabric (ug/g) | 690 | 3615 | 1996 | 1970 | 4663 | 2744 |

^{a} Fabric Softener Active (FSA) = N,N-di(alkanoyloxyethyl)-N,N-dimethylammonium chloride where alkyl consists predominantly of C16-C18 alkyl chains with an IV value of about 20 available from Evonik Industries.
^{b} LMW Polymer (P1.2 from Table 1): Dimethylamino Ethyl Acrylate methochloride (DMA3-MeCl) + Acrylamide (AM) in a 60:40 wt ratio, respectively, with an average molecular weight of about 210 kDal.
^{c1} MMW Polymer (P2.1 from Table 1): Dimethylamino Ethyl Acrylate methochloride (DMA3-MeCl) + Acrylamide (AM) in a 60:40 wt ratio, respectively, with an average molecular weight of about 725 kDal.
^{c2} MMW Polymer (P2.4 from Table 1): Dimethylamino Ethyl Acrylate methochloride (DMA3-MeCl) + Acrylamide (AM) in a 80:20 wt ratio, respectively, with an average molecular weight of about 725 kDal.
^{d} XL Polymer (P3.1 from Table 1): DimethylAmino Ethyl MethAcrylate methochloride (DMAEMA-MeCl) + Acrylamide (AM) in a 90:10 wt ratio, respectively, with an average molecular weight of more than 2,000 kDal. (i.e., Flosoft FS222 ® is available from SNF Floerger).
^{e} XL Polymer (P3.6 from Table 1): Dimethylamino Ethyl Acrylate methochloride (DMA3-MeCl) + Acrylamide (AM) in a 80:20 wt ratio, respectively, with an average molecular weight of more than 2,000 kDal. (i.e., Rheovis CDX ® is available from BASF).
^{f} Polyacrylate (PAC) perfume microcapsules (PMCs) from Appleton Papers, Inc.
^{g} Melamine Formaldehyde (MF) perfume microcapsules (PMCs) from Appleton Papers, Inc.

### Example 5: Ingredient Amounts Provided in Wt %, Unless Otherwise Indicated

| | F15 | |
|---|---|---|
| Formula | (Comparative) | F16 |
| FSA ^{a} | 6.0 | 6.0 |
| LMW Polymer ^{b} | 0.14 | — |
| MMW Polymer ^{c} | — | 0.14 |
| XL Polymer ^{d} | 0.11 | 0.11 |
| Perfume Encapsulate (PAC) ^{f} | 0.21 | 0.21 |
| Perfume Encapsulate (MF) ^{g} | 0.13 | 0.13 |
| Perfume Oil | 0.60 | 0.60 |
| Minors and Deionized Water | Balance | Balance |
| FSA Deposition on Fabric (ug/g) | 1567 | 1754 |
| Viscosity @ 1 Week (cps) | 104 | 240 |

^{a} Fabric Softener Active (FSA) = N,N-di(alkanoyloxyethyl)-N,N-dimethylammonium chloride where alkyl consists predominantly of C16-C18 alkyl chains with an IV value of about 20 available from Evonik Industries.
^{b} LMW Polymer (P1.1 from Table 1): Dimethylamino Ethyl Acrylate methochloride (DMA3-MeCl) + Acrylamide (AM) in a 80:20 wt ratio, respectively, with an average molecular weight of about 275 kDal.
^{c} MMW Polymer (P2.1 from Table 1): Dimethylamino Ethyl Acrylate methochloride (DMA3-MeCl) + Acrylamide (AM) in a 60:40 wt ratio, respectively, with an average molecular weight of about 725 kDal.
^{d} XL Polymer (P3.1 from Table 1): DimethylAmino Ethyl MethAcrylate methochloride (DMAEMA-MeCl) + Acrylamide (AM) in a 90:10 wt ratio, respectively, with an average molecular weight of more than 2,000 kDal. (i.e., Flosoft FS222 ® is available from SNF Floerger).
^{f} Polyacrylate (PAC) perfume microcapsules (PMCs) from Appleton Papers, Inc.
^{g} Melamine Formaldehyde (MF) perfume microcapsules (PMCs) from Appleton Papers, Inc.

### Example 6: Ingredient Amounts Provided in Wt %, Unless Otherwise Indicated

| | F17 | | | |
|---|---|---|---|---|
| Formula | (Comparative) | F18 | F19 | F20 |
| FSA ^{a} | 9.7 | 9.7 | 9.7 | 9.7 |
| LMW Polymer ^{b} | 0.10 | — | — | — |
| MMW Polymer ^{c} | — | 0.10 | 0.10 | 0.10 |
| XL Polymer ^{d} | 0.10 | 0.15 | 0.10 | 0.05 |
| Perfume Encapsulate | 0.21 | 0.21 | 0.21 | 0.21 |
| (PAC) ^{f} | | | | |
| Perfume Encapsulate | 0.13 | 0.13 | 0.13 | 0.13 |
| (MF) ^{g} | | | | |
| Perfume Oil | 0.60 | 0.60 | 0.60 | 0.60 |
| Minors and Deionized | Balance | Balance | Balance | Balance |
| Water | | | | |
| Viscosity (cP) @ 1 Month | 227 | 464 | 330 | 217 |
| Phase Instability (%) @ | 0 | 0 | 0 | 0 |
| 1 Month | | | | |

^{a} Fabric Softener Active (FSA) = N,N-di(alkanoyloxyethyl)-N,N-dimethylammonium chloride where alkyl consists predominantly of C16-C18 alkyl chains with an IV value of about 20 available from Evonik Industries.
^{b} LMW Polymer (P1.2 from Table 1): Dimethylamino Ethyl Acrylate methochloride (DMA3-MeCl) + Acrylamide (AM) in a 80:20 wt ratio, respectively, with an average molecular weight of about 200 kDal.
^{c} MMW Polymer (P2.1 from Table 1): Dimethylamino Ethyl Acrylate methochloride (DMA3-MeCl) + Acrylamide (AM) in a 60:40 wt ratio, respectively, with an average molecular weight of about 725 kDal.
^{d} XL Polymer (P3.1 from Table 1): DimethylAmino Ethyl MethAcrylate methochloride (DMAEMA-MeCl) + Acrylamide (AM) in a 90:10 wt ratio, respectively, with an average molecular weight of more than 2,000 kDal. (i.e., Flosoft FS222 ® is available from SNF Floerger).
^{f} Polyacrylate (PAC) perfume microcapsules (PMCs) from Appleton Papers, Inc.
^{g} Melamine Formaldehyde (MF) perfume microcapsules (PMCs) from Appleton Papers, Inc.

### Example 7: Ingredient Amounts Provided in Wt %, Unless Otherwise Indicated

| | F21 | |
|---|---|---|
| Formula | (Comparative) | F22 |
| FSA ^{a} | 6.0 | 6.0 |
| LMW Polymer ^{b} | 0.14 | — |
| MMW Polymer ^{c} | — | 0.14 |
| XL Polymer ^{d} | 0.12 | 0.12 |
| Perfume Encapsulate (PAC) ^{f} | 0.21 | 0.21 |
| Perfume Encapsulate (MF) ^{g} | 0.13 | 0.13 |
| Perfume Oil | 0.60 | 0.60 |
| Minors and Deionized Water | Balance | Balance |
| PAC PMC Headspace ^{h} | 1.00 | 1.15 |
| MF PMC Headspace ^{h} | 1.00 | 1.25 |
| FSA Deposition on Fabric (ug/g) | 2350 | 2295 |
| Viscosity @ 1 Week (cps) | 245 | 487 |
| % Phase Instability @ 4 Months | 11 | 0 |

^{a} Fabric Softener Active (FSA) = N,N-di(alkanoyloxyethyl)-N,N-dimethylammonium chloride where alkyl consists predominantly of C16-C18 alkyl chains with an IV value of about 20 available from Evonik Industries.
^{b} LMW Polymer (P1.9 from Table 1): Dimethylamino Ethyl Acrylate methochloride (DMA3-MeCl), with an average molecular weight of about 150 kDal.
^{c} MMW Polymer (P2.7 from Table 1): Dimethylamino Ethyl Acrylate methochloride (DMA3-MeCl), with an average molecular weight of about 725 kDal.
^{d} XL Polymer (P3.1 from Table 1): DimethylAmino Ethyl MethAcrylate methochloride (DMAEMA-MeCl) + Acrylamide (AM) in a 90:10 wt ratio, respectively, with an average molecular weight of more than 2,000 kDal. (i.e., Flosoft FS222 ® is available from SNF Floerger).
^{f} Polyacrylate (PAC) perfume microcapsules (PMCs) from Appleton Papers, Inc.
^{g} Melamine Formaldehyde (MF) perfume microcapsules (PMCs) from Appleton Papers, Inc.
^{h} Fabric Headspace (HS) values (nM/L) normalized to 1.0

### Example 8. Fabric Preparation Example

Fabrics are assessed using Kenmore FS 600 series washer machines. Wash Machines are set at: 32° C./15° C. wash/rinse temperature, 6 gpg hardness, normal cycle, and medium water fill (64 liters). Fabric bundles consist of 2.3 kilograms of clean fabric consisting of 100% cotton. Test swatches are included with this bundle and comprise of 100% cotton Euro Touch terrycloth towels (purchased from Standard Textile, Inc. Cincinnati, OH). Prior to treatment with any test products, the fabric bundles are stripped according to the Fabric Preparation-Stripping and Desizing procedure before running the test. Tide Heavy Duty Liquid (HDL) detergent is added under the surface of the water after the machine is at least half full. Once the water stops flowing and the washer begins to agitate, the clean fabric bundle is added.

When the machine is almost full of rinse water, and before agitation has begun, the fabric care testing composition is slowly added, ensuring that none of the fabric care testing composition comes in direct contact with the test swatches or fabric bundle. When the wash/rinse cycle is complete, each wet fabric bundle is transferred to a corresponding dryer. The dryer used is a Maytag commercial series (or equivalent) electric dryer, with the timer set for 55 minutes on the cotton/high heat/timed dry setting. This process is repeated for a total of three (3) complete wash-dry cycles. After the third drying cycle and once the dryer stops, 12 Terry towels from each fabric bundle are removed for actives deposition analysis. The fabrics are then placed in a constant Temperature/Relative Humidity (21° C., 50% relative humidity) controlled grading room for 12-24 hours and then graded for softness and/or actives deposition.

The Fabric Preparation-Stripping and Desizing procedure includes washing the clean fabric bundle (2.5 kg of fabric comprising 100% cotton) including the test swatches of 100% cotton EuroTouch terrycloth towels for 5 consecutive wash cycles followed by a drying cycle. AATCC (American Association of Textile Chemists and Colorists) High Efficiency (HE) liquid detergent is used to strip/de-size the test swatch fabrics and clean fabric bundle (lx recommended dose per wash cycle). The wash conditions are as follows: Kenmore FS 600 and/or 80 series wash machines (or equivalent), set at: 48° C./48° C. wash/rinse temperature, water hardness equal to 0 gpg, normal wash cycle, and medium sized load (64 liters). The dryer timer is set for 55 minutes on the cotton/high/timed dry setting.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to the term in this written document shall govern.

While particular aspects of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A liquid fabric treatment composition comprising, based upon total composition weight:
a) from about 0.01% to about 2% of a MMW polymer derived from the polymerization of from about 5 to 100 mole percent of a cationic vinyl addition monomer, from about 0 to 95 mole percent of a non-ionic vinyl addition monomer, wherein the molecular weight of the MMW polymer is from about 400,000 to about 1,800,000 Daltons, and
b) from about 1% to about 25% of a fabric softener active material.

2. The liquid fabric treatment composition of claim 1, wherein the MMW polymer is a linear polymer, having not been made in the presence of a cross-linker.

3. The liquid fabric treatment composition of claim 1, wherein the molecular weight of the MMW polymer is from about 550,000 to about 1,200,000 Daltons.

4. The liquid fabric treatment composition of claim 1, wherein the molecular weight of the MMW polymer is from about 600,000 to about 850,000 Daltons.

5. The liquid fabric treatment composition of claim 1, wherein the composition comprises, based upon total composition weight, about 0.02% to about 0.5%, of MMW polymer.

6. The liquid fabric treatment composition of claim 1, wherein the composition comprises, based upon total composition weight, about 0.04% to about 0.25%, of MMW polymer.

7. The liquid fabric treatment composition of claim 1, wherein the composition comprises, based upon total composition weight, about 0.05% to about 0.15%, of MMW polymer.

8. The liquid fabric treatment composition of claim 1, wherein the composition comprises, based upon total composition weight, about 0.05% to about 0.12%, of MMW polymer.

9. The liquid fabric treatment composition of claim 1, further comprising an XL polymer, wherein the molecular weight of the XL polymer is from about 1,200,000 to about 6,000,000 Daltons.

10. The liquid fabric treatment composition of claim 9, wherein the composition comprises, based upon total composition weight, about 0.02% to about 1%, of XL polymer.

11. The liquid fabric treatment composition of claim 9, wherein the composition comprises, based upon total composition weight, about 0.03% to about 0.4%, of XL polymer.

12. The liquid fabric treatment composition of claim 9, wherein the composition comprises, based upon total composition weight, about 0.04% to about 0.25%, of XL polymer.

13. The liquid fabric treatment composition of claim 9, wherein the composition comprises, based upon total composition weight, about 0.05% to about 0.15%, of XL polymer.

14. The liquid fabric treatment composition of claim 9, wherein the composition comprises, based upon total composition weight, about 0.06% to about 0.10%, of XL polymer.

15. The liquid fabric treatment composition of claim 9, wherein the molecular weight of the XL polymer is from about 1,500,000 to about 5,000,000 Daltons.

16. The liquid fabric treatment composition of claim 9, wherein the molecular weight of the XL polymer is from about 1,800,000 to about 4,000,000 Daltons.

17. The liquid fabric treatment composition of claim 9, wherein the ratio of weight of XL polymer to MMW polymer is from about 1:5 to about 5:1.

18. The liquid fabric treatment composition of claim 9, wherein the ratio of weight of XL polymer to MMW polymer is from about 1:3 to about 3:1.

19. The liquid fabric treatment composition of claim 9, wherein the ratio of weight of XL polymer to MMW polymer is from about 1:2 to about 2:1.

20. The liquid fabric treatment composition of claim 1, wherein the composition comprises from about 3% to about 20% of the fabric softener active material.
